(19) United States
(12) Patent Application Publication
(10) Pub. No.: US 2022/0283379 A1
(43) Pub. Date: Sep. 8, 2022

(54) OPTICAL FIBER FEEDTHROUGH

(71) Applicant: KOHOKU KOGYO CO., LTD., Nagahama-shi, Shiga (JP)

(72) Inventors: Hirokazu FUJITANI, Nagahama-shi, Shiga (JP); Ichiro TERAMURA, Nagahama-shi, Shiga (JP); Jun YAMAMOTO, Nagahama-shi, Shiga-ken (JP); Ryuji HAYASHI, Nagahama-shi, Shiga (JP)

(73) Assignee: KOHOKU KOGYO CO., LTD., Nagahama-shi, Shiga (JP)

(21) Appl. No.: 17/637,036

(22) PCT Filed: Aug. 19, 2020
(86) PCT No.: PCT/JP2020/031284

§ 371 Date: Feb. 21, 2022

(30) Foreign Application Priority Data
Aug. 22, 2019 (JP) 2019-151887

(51) Int. Cl. G02B 6/36

(52) U.S. Cl. CPC G02B 6/3616

(57) ABSTRACT

An optical fiber feedthrough includes a tubular-shaped sleeve and an elastic tube. The sleeve includes a through hole extending in an axial direction and is mountable to a package such that an end portion thereof on one side is located on an inner side of the package and an end portion thereof on an other side is located on an outer side of the package. The elastic tube includes an insertion portion entering the inside of the through hole from an outer end portion being an end portion on the other side of the through hole, and a projection portion projecting to the outside from the outer end portion. An optical fiber is insertable into the through hole and the elastic tube, and an outer peripheral surface of the elastic tube and an inner peripheral surface of the through hole are fixed to each other with an adhesive.

### TECHNICAL FIELD

The present invention relates to an optical fiber feedthrough.

### BACKGROUND ART

An optical element arranged inside of a package of an optical module is optically coupled to an optical fiber in the package in order to perform optical communication with any device arranged outside of the package. The optical fiber optically coupled to the optical element in the package is led to the outside via an optical fiber feedthrough. At this time, in order to prevent deterioration of the optical element due to dew condensation in the package, an electrical short-circuit, or the like, the package is air-tightly/hermetically sealed. In order to ensure the airtightness of the package, there has been used a configuration in which a sealing material is loaded between a sleeve being a component of the optical fiber feedthrough and the optical fiber inserted into the sleeve, or a configuration in which the sleeve and the optical fiber are bonded to each other with an adhesive.

In Patent Literature 1, there is disclosed a package structure of an optical fiber introduction portion in which a tubular member (sleeve) is fixed to an outer wall of the package. Specifically, an inner wall of the tubular member and an optical fiber bare wire part are fixed to each other with solder, the inner wall of the tubular member and an optical fiber core wire part are fixed to each other with an adhesive, and the tubular member and the package are fixed to each other with solder containing flux.

### CITATION LIST

### Patent Literature

[PTL 1] JP 2005-17743 A

### SUMMARY OF INVENTION

### Problem to be Solved by Invention

When an optical fiber projecting to the outside of the package from the sleeve of the optical fiber feedthrough is bent and deformed, a load is applied also to the adhesive for bonding the optical fiber to the sleeve or the sealing material loaded inside of the sleeve. Accordingly, when the optical fiber is bent and deformed, the adhesive or the sealing material may be damaged, or a gap may be generated between the optical fiber and the adhesive or the sealing material. Thus, there is a fear in that the airtightness cannot be kept.

The present invention has been made in view of the above-mentioned circumstances, and has an object to provide an optical fiber feedthrough with which airtightness of a package can be ensured even when an optical fiber is bent and deformed.

### Solution to Problem

According to one embodiment of the present invention, there is provided an optical fiber feedthrough (1a, 1b) for performing optical communication via an optical fiber (50) between an element accommodated inside of an air-tightly sealed package (60) and any device arranged outside of the package (60), the optical fiber feedthrough (1a, 1b) being mountable to the package (60).

The optical fiber feedthrough (1a, 1b) includes: a sleeve (20) which has a tubular shape, and includes an end portion on a first direction (D1) side and an end portion on a second direction (D2) side, the first direction (D1) being one direction along an axial direction and the second direction (D2) being an other direction along the axial direction, the sleeve (20) being mountable to the package (60) such that the end portion on the first direction (D1) side is located on an inner side of the package (60) and the end portion on the second direction (D2) side is located on an outer side of the package (60), the sleeve (20) further including a through hole (21) which extends in the axial direction and allows communication between the inside and the outside of the package (60); and an elastic tube (30) including: an insertion portion (32) entering the inside of the through hole (21) from an outer end portion being an end portion on the second direction (D2) side of both end portions of the through hole (21) of the sleeve (20); and a projection portion (33) projecting to the outside of the sleeve (20) from the outer end portion.

The optical fiber (50) is insertable into the through hole (21) of the sleeve (20) and the elastic tube (30), and an outer peripheral surface of the elastic tube (30) and an inner peripheral surface of the through hole (21) of the sleeve (20) are fixed to each other with an adhesive (40).

When the invention is configured as described above, the airtightness of the package (60) can be ensured even when the optical fiber (50) is bent and deformed.

### BRIEF DESCRIPTION OF DRAWINGS

FIG. 1 is an exterior perspective view of an optical fiber feedthrough according to an embodiment of the present invention.

FIG. 2 is a front elevation view (front view) of the optical fiber feedthrough.

FIG. 3 is a right side view of the optical fiber feedthrough.

FIG. 4 is a left side view of the optical fiber feedthrough.

FIG. 5 is a sectional view of the optical fiber feedthrough.

FIG. 6 is a sectional view as viewed from the arrow VI-VI of FIG. 5.

FIG. 7 is a sectional view for schematically illustrating a state in which an optical fiber inserted into the optical fiber feedthrough is bent and deformed.

FIG. 8 is a sectional view for schematically illustrating a state in which an optical fiber inserted into an optical fiber feedthrough of a comparative example including no elastic tube is bent and deformed.

FIG. 9 is an exterior perspective view of an optical fiber feedthrough according to a modification example of the embodiment of the present invention.

FIG. 10 is a front elevation view (front view) of the optical fiber feedthrough.

FIG. 11 is a plan view (top view) of the optical fiber feedthrough.

FIG. 12 is a right side view of the optical fiber feedthrough.

FIG. 13 is a left side view of the optical fiber feedthrough.

FIG. 14 is a sectional view of the optical fiber feedthrough.

FIG. 15 is a sectional view as viewed from the arrow XV-XV of FIG. 14.

### DESCRIPTION OF EMBODIMENTS

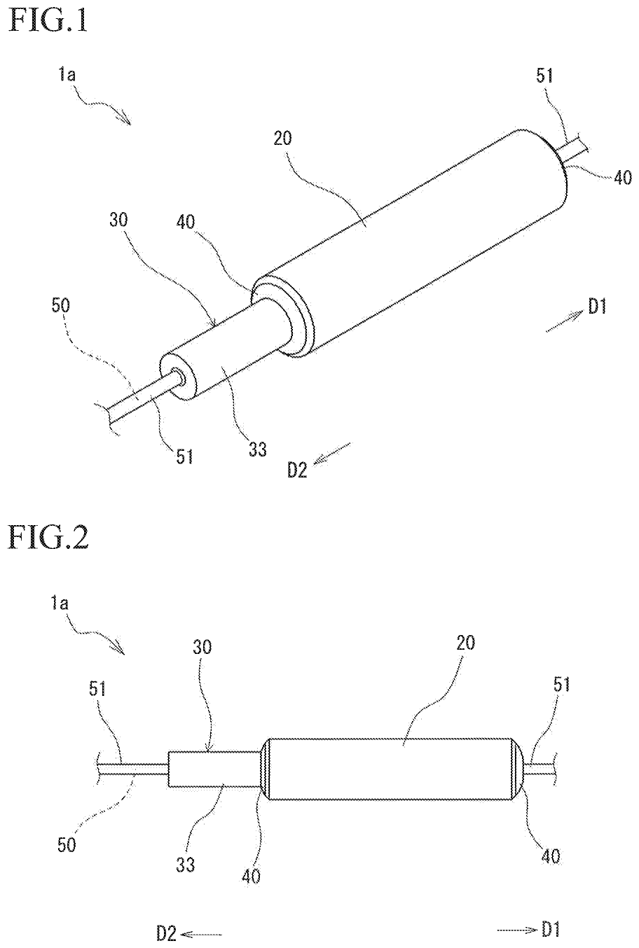

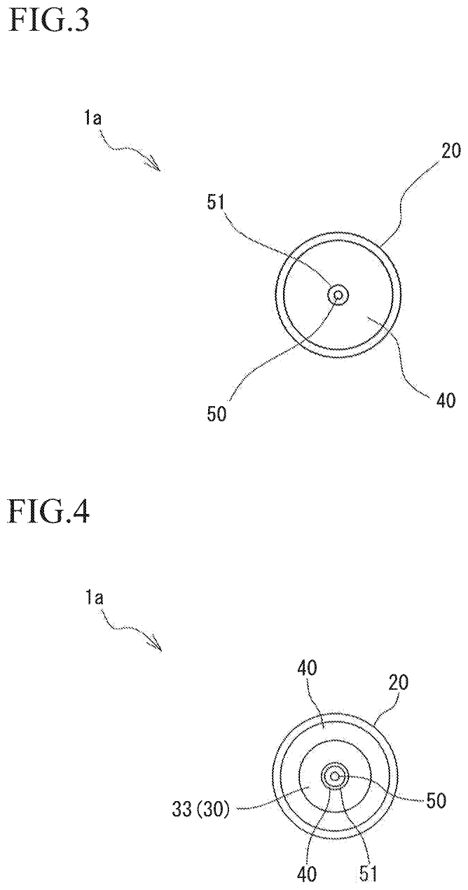

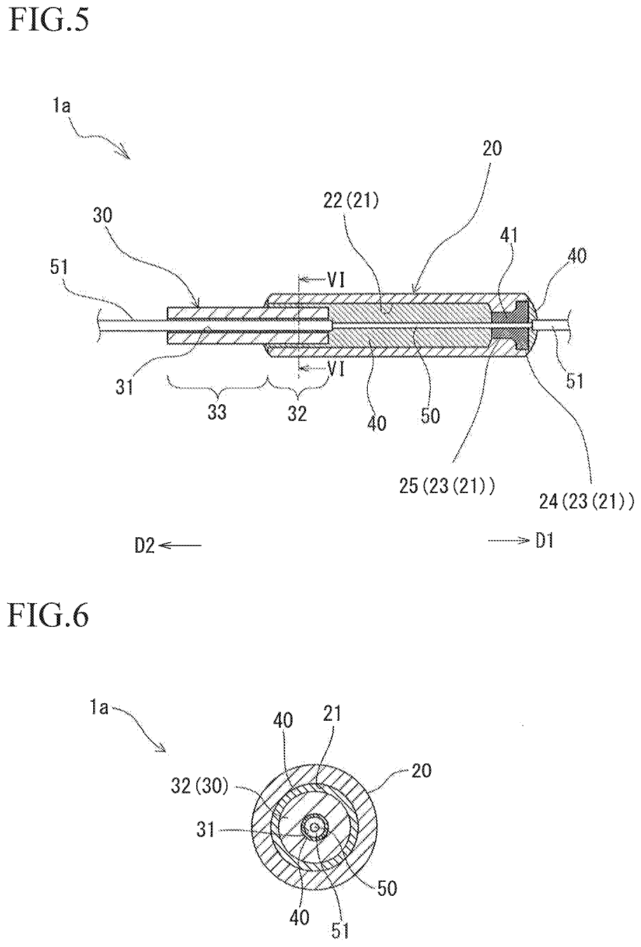

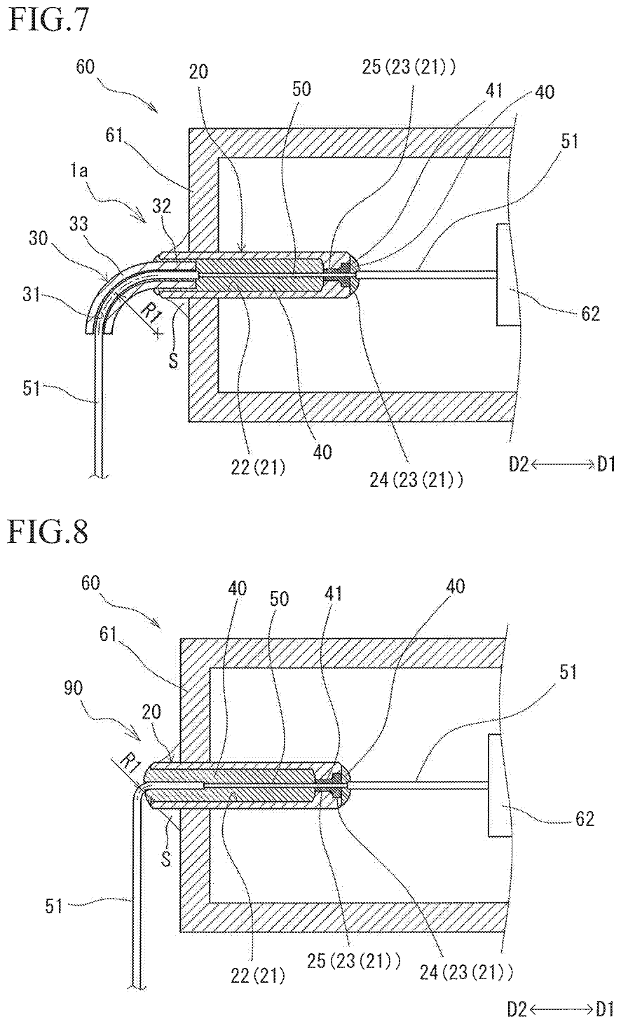

Now, an optical fiber feedthrough 1a according to an embodiment of the present invention is described with reference to the drawings. FIG. 1 to FIG. 6 are views for illustrating a state in which an optical fiber 50 is inserted into the optical fiber feedthrough 1a according to the embodiment of the present invention. FIG. 1 is an exterior perspective view, FIG. 2 is a front elevation view (front view), FIG. 3 is a right side view, FIG. 4 is a left side view, FIG. 5 is a sectional view taken along a plane including an axis, and FIG. 6 is a sectional view as viewed from the arrow VI-VI of FIG. 5. As illustrated in those drawings, the optical fiber feedthrough 1a according to the embodiment of the present invention has a substantially cylindrical shape, and is rotationally symmetric about its axis. Accordingly, the back view, the plan view (top view), and the bottom view are the same as the front elevation view (front view). It should be noted that, in FIG. 5, illustration of the optical fiber 50 located in a coating material 51 is omitted. The same holds true also for FIG. 7, FIG. 8, and FIG. 14 to be referred to later.

The optical fiber feedthrough 1a according to the embodiment of the present invention is mountable to a package 60 in order to perform optical communication via the optical fiber 50 between an optical element 62 (see FIG. 7), which is air-tightly/hermetically sealed inside of the package 60, and any device (not shown) arranged outside of the package 60. The optical fiber feedthrough 1a according to the embodiment of the present invention is applicable to the package 60 including the optical element 62 air-tightly sealed therein, and the type and the structure of the package 60 are not particularly limited. In each drawing, one direction along an axial direction of the optical fiber feedthrough 1a is defined as a “first direction D1,” and an other direction along the axial direction of the optical fiber feedthrough 1a is defined as a “second direction D2” (as the respective directions, see, for example, arrow D1 and arrow D2 of FIG. 1). Further, in the following description, “the optical fiber feedthrough according to the embodiment of the present invention” is sometimes abbreviated and simply referred to as “feedthrough.”

As illustrated in FIG. 1 to FIG. 4, the feedthrough 1a includes a sleeve 20 having a cylindrical shape, and an elastic tube 30 having a cylindrical shape. The axis of the sleeve 20 and the axis of the elastic tube 30 are the same. The axis of the feedthrough 1a matches the axis of the sleeve 20 and the axis of the elastic tube 30. A part of the elastic tube 30 on the first direction D1 side is inserted inside of the sleeve 20 (described later). The optical fiber 50 is inserted into the inside of the elastic tube 30 and the inside of the sleeve 20. The feedthrough 1a is configured so that the optical element 62 accommodated inside of the package 60 can perform optical communication via this optical fiber 50 with any device arranged outside of the package 60 (see FIG. 7).

The sleeve 20 is a member mountable to an outer wall 61 (see FIG. 7) of the package 60. Specifically, the sleeve 20 is mountable to the package 60 such that an end portion on the first direction D1 side is located on an inner side of the package 60, and an end portion on the second direction D2 side is located on an outer side of the package 60 (see FIG. 7). The sleeve 20 is formed of a metal material so that the sleeve 20 can be brazed to the outer wall 61 of the package 60. As illustrated in FIG. 5 and FIG. 6, the sleeve 20 has a through hole 21 extending in the axial direction. The through hole 21 passes through the sleeve 20 in its axial direction. Accordingly, when the sleeve 20 is mounted to the outer wall 61 of the package 60, an end portion of the through hole 21 on the first direction D1 side is located on the inner side of the package 60, and an end portion thereof on the second direction D2 side is located on the outer side of the package 60 (see FIG. 7). That is, the through hole 21 communicates between the inside and the outside of the package 60. This through hole 21 is formed so as to allow the optical fiber 50 to be inserted thereinto. In addition, the axis of the through hole 21 and the axis of the sleeve 20 are the same. In the following description, the end portion on the second direction side (that is, the end portion to be located on the outer side of the package 60) of both the end portions of the through hole 21 is referred to as “outer end portion.”

As illustrated in FIG. 5, the through hole 21 of the sleeve 20 includes a first part 22 and a second part 23. The first part 22 is located on the second direction D2 side with respect to the second part 23. The first part 22 is a part into which the elastic tube 30 is to be inserted, and has an inner diameter larger than an outer diameter of the elastic tube 30. The second part 23 is located on the first direction D1 side with respect to the first part 22. The second part 23 is a part to be filled with a glass 41. In this embodiment, the second part 23 includes a large diameter portion 24 located on the first direction D1 side, and a small diameter portion 25 located on the second direction D2 side. In other words, the large diameter portion 24 is located at the end portion of the through hole 21 on the first direction D1 side, and the small diameter portion 25 is located between the large diameter portion 24 and the first part 22. The small diameter portion 25 is a part having an inner diameter smaller than those of the large diameter portion 24 and the first part 22. However, the second part 23 is only required to be formed so that the optical fiber 50 can be inserted thereinto and the glass 41 can be loaded therein, and the second part 23 is not limited to the above-mentioned configuration.

In this embodiment, there is shown a configuration in which the sleeve 20 has a cylindrical shape, but the shape of the sleeve 20 is not limited to a cylindrical shape. The sleeve 20 is only required to be configured so that the sleeve 20 is mountable to the package 60 in which the optical element 62 is air-tightly sealed and has the through hole 21 for communicating between the inside and the outside of the package 60 under the mounted state, and so that the through hole 21 includes the first part 22. Further, in this embodiment, there is shown a configuration in which the sleeve 20 is formed of a metal material so that the sleeve 20 can be brazed to the outer wall 61 of the package 60, but the sleeve 20 is not limited to the configuration of being formed of the metal material. For example, the sleeve 20 may be configured to be formed of an inorganic material, for example, any of various ceramic materials.

As illustrated in FIG. 1, FIG. 2, and FIG. 4 to FIG. 6, the elastic tube 30 is mounted to the sleeve 20. The elastic tube 30 is a tube-shaped member which is elastically bendable and deformable. As such an elastic tube 30, a tube formed of a resin material can be applied. As the resin material, for example, tetrafluoroethylene, trifluoroethylene, or Hytrel (“Hytrel” is a trademark of “E. I. du Pont de Nemours and Company”) can be applied. Further, the elastic tube 30 has a through hole 31 passing therethrough in its axial direction. The through hole 31 is formed so that the optical fiber 50 coated with the coating material 51 can be inserted thereinto. In addition, the axis of the through hole 31 and the axis of the elastic tube 30 are the same. In this embodiment, there is shown a configuration in which the elastic tube 30 has a cylindrical shape, but the shape of the elastic tube 30 is not limited to a cylindrical shape.

A part of the elastic tube 30 on the first direction D1 side enters the first part 22 of the through hole 21 from the outer end portion of the through hole 21 of the sleeve 20 (that is, the end portion of the through hole 21 on the second direction D2 side) (see FIG. 5). In this manner, the end portion of the elastic tube 30 on the first direction D1 side is located inside of the first part 22. Further, as illustrated in FIG. 1, FIG. 2, and FIG. 5, a part of the elastic tube 30 on the second direction D2 side projects to the outside of the sleeve 20 from the outer end portion of the through hole 21. In this manner, the end portion of the elastic tube 30 on the second direction D2 side is located outside of the sleeve 20. As described above, the elastic tube 30 includes a part (insertion portion 32) entering inside of the through hole 21 from the outer end portion of the through hole 21 of the sleeve 20, and a part (projection portion 33) projecting to the outside of the sleeve 20 from the outer end portion. As illustrated in FIG. 5, the elastic tube 30 is only required to enter a part of the first part 22 of the through hole 21 of the sleeve 20 (predetermined range from the outer end portion of the sleeve 20), and is not required to enter the entire range of the first part 22 of the through hole 21.

Further, the optical fiber 50 is inserted into the through hole 31 of the elastic tube 30 and the through hole 21 of the sleeve 20. The axis of the optical fiber 50 is the same as the axis of the through hole 31 and the axis of the through hole 21 (see FIG. 3, FIG. 4, and FIG. 6). As illustrated in FIG. 5, on a part of the optical fiber 50 located inside of the through hole 31, the coating material 51 is left without being removed. Further, on a part of the optical fiber 50 located inside of the second part 23 of the through hole 21, the coating material 51 is removed. On a part of the optical fiber 50 located inside of the first part 22 of the through hole 21 and projecting from the elastic tube 30, the coating material 51 in a part on the side close to the elastic tube 30 is left without being removed, and the coating material 51 in the remaining part is removed. That is, the coating material 51 is removed in a part of the optical fiber 50 located inside of the second part 23 of the sleeve 20 and a part of the optical fiber 50 which is successive to this part and extends to the middle of the inside of the first part 22 of the sleeve 20. The coating material 51 is left without being removed in the other parts.

As illustrated in FIG. 5 and FIG. 6, an adhesive 40 is loaded between an outer peripheral surface of the insertion portion 32 of the elastic tube 30 and an inner peripheral surface of the first part 22 of the through hole 21 of the sleeve 20. In this manner, the outer peripheral surface of the insertion portion 32 of the elastic tube 30 and the inner peripheral surface of the first part 22 of the through hole 21 of the sleeve 20 are fixed to each other with the adhesive 40. Further, the adhesive 40 is also loaded inside of the through hole 31 of the elastic tube 30. In this manner, an outer peripheral surface of the coating material 51 of the optical fiber 50 and an inner peripheral surface of the through hole 31 of the elastic tube 30 are fixed to each other. In other words, the elastic tube 30 is attached to the optical fiber 50.

Inside of the first part 22 of the through hole 21 of the sleeve 20, the adhesive 40 is also loaded in a part in which the insertion portion 32 of the elastic tube 30 is absent. In this manner, in the first part 22 of the through hole 21 of the sleeve 20, the optical fiber 50 and its coating material 51 projecting from the insertion portion 32 of the elastic tube 30 are fixed to an inner peripheral surface of the first part 22 with the adhesive 40.

The second part 23 is filled with the glass 41. In this manner, the optical fiber 50 is fixed to the sleeve 20, and a gap between the optical fiber 50 and an inner peripheral surface of the second part 23 of the through hole 21 of the sleeve 20 is sealed. Further, the adhesive 40 is applied at an end portion of the large diameter portion 24 of the through hole 21 of the sleeve 20 on the first direction D1 side (that is, the end portion to be located on the inner side of the package 60), and this adhesive 40 causes the coating material 51 of the optical fiber 50 to be bonded to the sleeve 20.

As described above, with the adhesive 40 and the glass 41 loaded inside of the through hole 21 of the sleeve 20, a space between the sleeve 20 and the optical fiber 50 inserted into the inside of the sleeve 20 is air-tightly sealed. Further, a space between an outer periphery of a part of the sleeve 20 projecting to the outside from the outer wall 61 of the package 60 and an outer part of the outer wall 61 of the package 60 is air-tightly sealed with a solder S (see FIG. 7). In this manner, the airtightness of the package 60 is kept. The adhesive 40 and the glass 41 are not particularly limited. Various adhesives and various glasses publicly known in the related art can be applied, or solder can be used in place of glass.

Next, an effect of the feedthrough 1a including the elastic tube 30 is described while comparing to a feedthrough 90 including no elastic tube 30. FIG. 7 is a sectional view for schematically illustrating a state in which the optical fiber 50 is bent and deformed regarding the feedthrough 1a mounted to the package 60. FIG. 8 is a sectional view for schematically illustrating a state in which the optical fiber 50 is bent and deformed regarding the feedthrough 90 mounted to the package 60. The feedthrough 90 includes no elastic tube 30.

As illustrated in FIG. 8, in the feedthrough 90 including no elastic tube 30, when the optical fiber 50 projecting to the outside of the package 60 from the sleeve 20 (hereinafter also simply referred to as “projecting part of the optical fiber 50”) is applied with a bending load so as to be bent and deformed, the adhesive 40 in the vicinity of the end portion of the sleeve 20 on the second direction D2 side (outer end portion of the through hole 21) is applied with a force from the optical fiber 50. For example, when the projecting part of the optical fiber 50 is bent and deformed such that the axis of the projecting part of the optical fiber 50 forms 90° with respect to the axis of the optical fiber 50 inside of the through hole 21 of the sleeve 20 (that is, the axis of the sleeve 20), the adhesive 40 in the vicinity of the end portion of the sleeve 20 is applied with a force from the optical fiber 50 in a direction perpendicular to the axis of the sleeve 20. This force is increased as a curvature radius R1 of a bending deformation portion of the optical fiber 50 is decreased. Further, when the feedthrough 90 includes no elastic tube 30, this force is increased because the curvature radius R1 of the bending deformation portion of the optical fiber 50 is decreased. Accordingly, there is a fear in that the adhesive 40 may be damaged to cause easy entry of moisture or the like into the sleeve 20, thereby degrading the airtightness. Further, when the curvature radius R1 of the bending deformation portion is decreased, there is a fear in that a bending loss of the optical fiber 50 is increased, thereby being incapable of obtaining desired optical characteristics.

In contrast, as illustrated in FIG. 7, in the feedthrough 1a including the elastic tube 30, when a bending load is applied to the optical fiber 50, the projection portion 33 of the elastic tube 30 is bent together with the optical fiber 50. Accordingly, as compared to the case in which the elastic tube 30 is absent, the curvature radius R1 of the bending deformation portion of the optical fiber 50 is increased, and a force that the adhesive 40 in the vicinity of the end portion of the sleeve 20 (outer end portion of the through hole 21) receives from the optical fiber 50 and the elastic tube 30 (force received due to the bending deformation) is decreased. Thus, the damage of the adhesive 40 is prevented or suppressed, and the airtightness is kept. Further, the curvature radius R1 of the bending deformation portion of the optical fiber 50 is increased, and hence the bending loss of the optical fiber 50 is reduced, thereby being capable of ensuring the desired optical characteristics.

The elastic tube is formed such that, when the elastic tube is bent into an L shape under a state in which the optical fiber is inserted thereinto, the curvature radius of the bending deformation portion of the optical fiber becomes equal to or larger than a curvature radius corresponding to an upper limit value of the standard of the bending loss of the optical fiber. In this case, “the elastic tube is bent into an L shape” means that a bending load is applied to the optical fiber, and, as a result, the axis of the part (of the projection portion) of the elastic tube on the second direction D2 side forms 90° with respect to the axis of the sleeve. In this embodiment, the elastic tube 30 is formed such that, under a state in which the projection portion 33 thereof is bent such that the axis of a part of the projection portion 33 on the second direction D2 side forms 90° with respect to the axis of the sleeve 20, the curvature radius R1 of the bending deformation portion of the optical fiber 50 becomes 7.5 mm or more. In this manner, the bending loss of the optical fiber 50 becomes equal to or smaller than the upper limit value of the standard. Thus, a transmission loss can be reduced, and desired optical characteristics can be obtained. The curvature radius R1 of the optical fiber 50 is not limited to be 7.5 mm or more, and is set in accordance with the upper limit value of the standard of the bending loss of the optical fiber 50. That is, the elastic tube 30 is formed such that, when the elastic tube 30 is bent into an L shape under a state in which the optical fiber 50 is inserted thereinto, the curvature radius R1 of the bending deformation portion of the optical fiber 50 becomes equal to or larger than a curvature radius corresponding to the upper limit value of the standard of the bending loss of the optical fiber 50. For example, when the optical fiber 50 transmits light having a wavelength of 1,550 nm, in a case in which the optical fiber 50 is formed such that the upper limit value of the standard of the bending loss when the optical fiber 50 is wound around a mandrel having a radius of 5 mm becomes 0.1 dB or less, the elastic tube 30 may be formed such that, when the elastic tube 30 is bent into an L shape under a state in which the optical fiber 50 is inserted thereinto, the curvature radius R1 of the bending deformation portion of the optical fiber 50 becomes 5 mm or more. When the elastic tube 30 is formed such that the bending loss of the optical fiber 50 becomes equal to or smaller than the upper limit value of the standard under a state in which the elastic tube 30 is bent into an L shape, a bending strength required for the optical fiber 50 (strength to the extent of being capable of withstanding a tension of 0.23 kg under a state of being bent by 90°) can also be ensured.

It is preferred that the elastic tube 30 have a rigidity lower than that of the sleeve 20 (easier to be bent and deformed), and a rigidity higher than that of the optical fiber 50 (harder to be bent and deformed). That is, it is preferred that a curvature radius R2 of a bending deformation portion of the elastic tube 30 in a case in which a bending load acts on the elastic tube 30 so that the elastic tube 30 is bent and deformed be larger than the curvature radius R1 of the bending deformation portion of the optical fiber 50 in a case in which the same bending load acts on the optical fiber 50 so that the optical fiber 50 is bent and deformed. As the specific rigidity, the rigidity is affected by a material, sectional dimensions (outer diameter and inner diameter), and a sectional shape of the elastic tube 30, and hence the material, the sectional dimensions, and the sectional shape of the elastic tube 30 may be determined such that the curvature radius R1 of the optical fiber 50 becomes 7.5 mm or more as described above.

Further, when an axial direction dimension of the projection portion 33 of the elastic tube 30 is excessively small, the optical fiber 50 is bent and deformed outside of the elastic tube 30. As a result, the curvature radius R1 of the bending deformation portion of the optical fiber 50 is decreased, and there is a fear in that the desired optical characteristics cannot be obtained. In view of the above, the axial direction dimension of the projection portion 33 of the optical fiber 50 is preferably 2 mm or more, more preferably 3 mm or more.

Further, when an axial direction dimension of the insertion portion 32 is excessively small, in a case in which a bending load acts on the optical fiber 50 and the elastic tube 30 so that those members are bent and deformed, there is a fear in that the elastic tube 30 may slip out of the sleeve 20. In view of the above, in order to prevent the elastic tube 30 from slipping out of the sleeve 20, the axial direction dimension of the insertion portion 32 of the elastic tube 30 is preferably 1 mm or more, more preferably 2 mm or more. When the axial direction dimension of the insertion portion 32 is 1 mm or more, in a case in which the elastic tube 30 is bent and deformed, the elastic tube 30 can be prevented or suppressed from slipping out of the sleeve 20. When the axial direction dimension of the insertion portion 32 is 2 mm or more, this effect can be further enhanced.

A thickness of the elastic tube 30 in a direction orthogonal to the axial direction (for example, a radial direction) is not particularly limited. However, from the viewpoint of reducing the bending loss of the optical fiber 50, the thickness is preferably 0.2 mm or more, more preferably 0.25 mm or more. When the thickness of the elastic tube 30 in the direction orthogonal to the axial direction is 0.2 mm or more, the effect of reducing the bending loss of the optical fiber 50 can be enhanced. When the thickness is 0.25 mm or more, this effect can be further enhanced.

### Modification Example

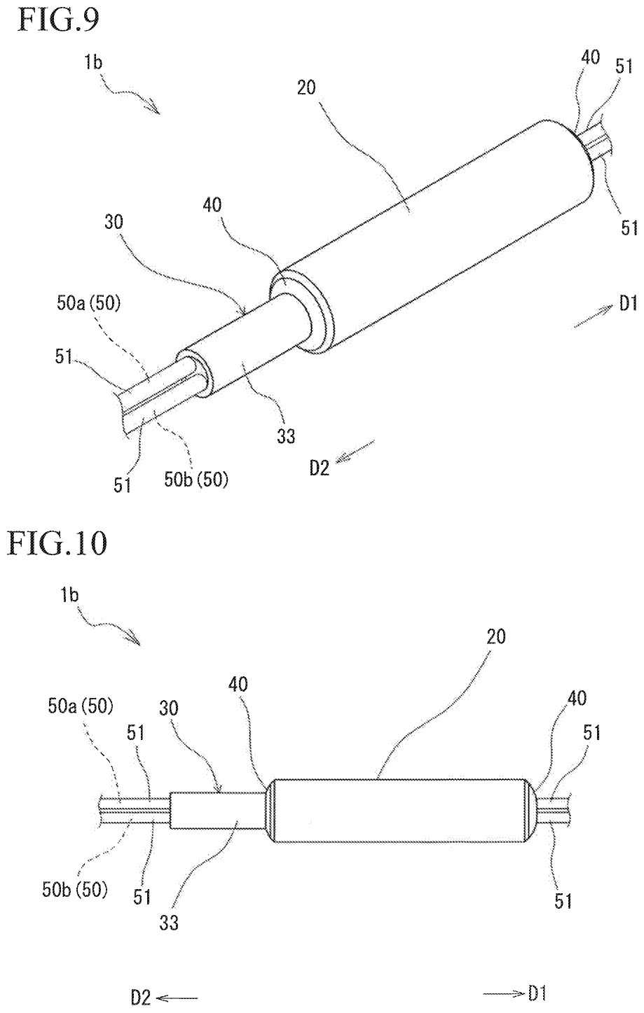

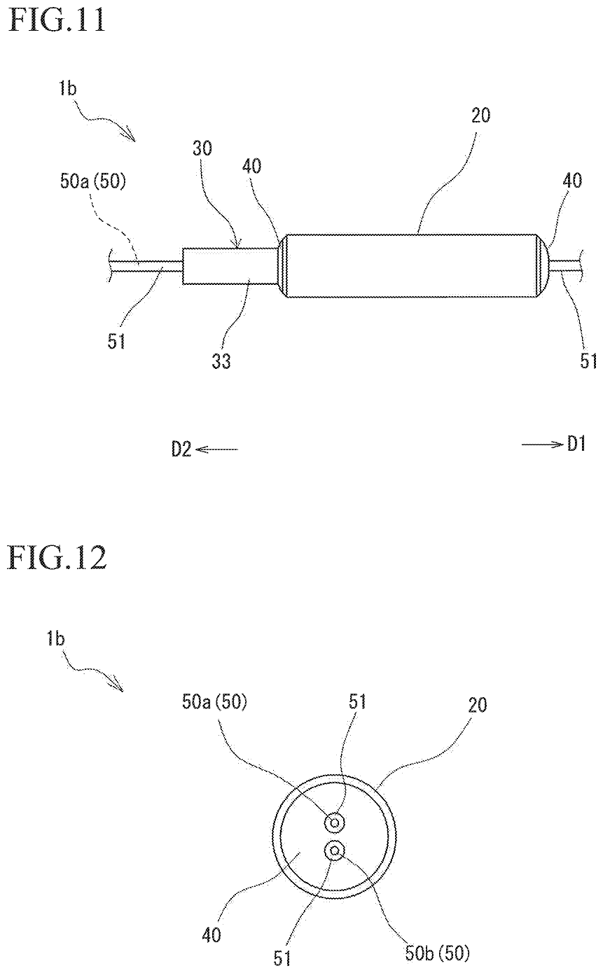

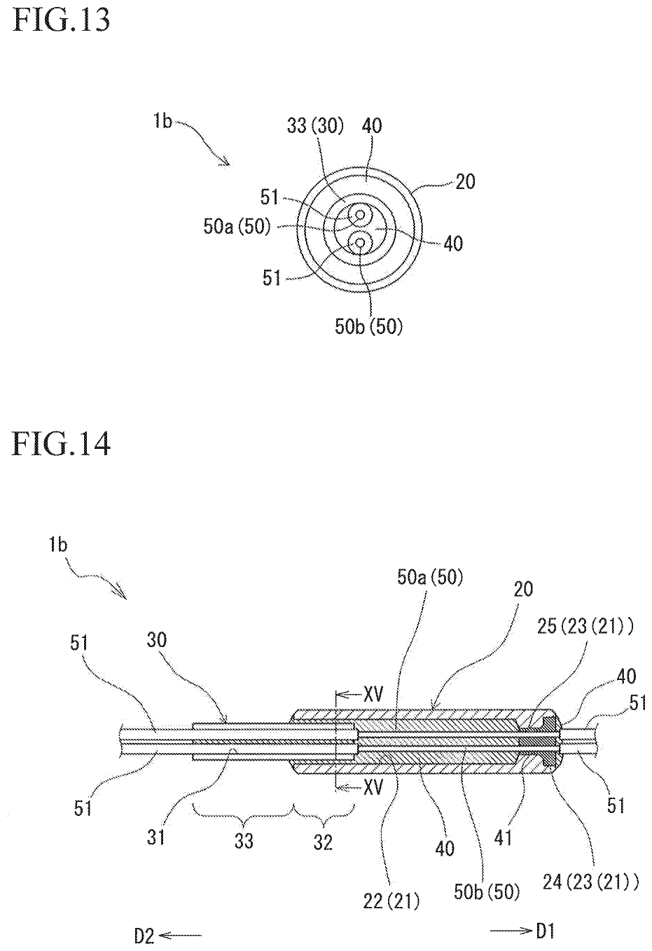

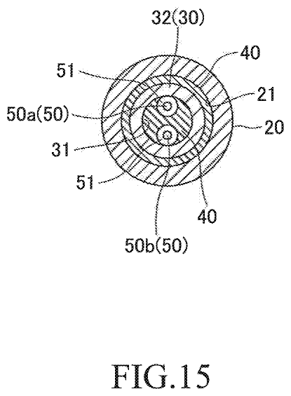

Next, an optical fiber feedthrough 1b according to a modification example is described with reference to the drawings. In this modification example, the optical fiber 50 includes a first optical fiber 50a and a second optical fiber 50b. FIG. 9 to FIG. 15 are views for illustrating a state in which the first optical fiber 50a and the second optical fiber 50b are inserted into the sleeve 20 and the elastic tube 30 of the feedthrough 1b according to the modification example. FIG. 9 is an exterior perspective view, FIG. 10 is a front elevation view (front view), FIG. 11 is a plan view (top view), FIG. 12 is a right side view, FIG. 13 is a left side view, FIG. 14 is a sectional view taken along a plane including an axis, and FIG. 15 is a sectional view as viewed from the arrow XV-XV of FIG. 14. The feedthrough 1b also has a substantially cylindrical shape. The back view is the same as the front elevation view (front view), and the bottom view is the same as the plan view (top view). The first optical fiber 50a is an optical fiber for transmitting an optical signal from the outside to the inside of the package 60, and the second optical fiber 50b is an optical fiber for transmitting an optical signal from the inside to the outside of the package 60.

As illustrated in FIG. 9 to FIG. 15, configurations similar to those of the above-mentioned embodiment can be applied to the sleeve 20 and the elastic tube 30 in the modification example (see FIG. 1 to FIG. 6). The first optical fiber 50a and the second optical fiber 50b are inserted into the through hole 31 of the elastic tube 30 and the through hole 21 of the sleeve 20. The first optical fiber 50a and the second optical fiber 50b are arranged (inserted) at such positions that their axes are separated away from the axis of the optical fiber feedthrough 1b (that is, the axis of the sleeve 20 and the axis of the elastic tube 30) in directions opposite to each other by the same distance (see, in particular, FIG. 12, FIG. 13, and FIG. 15). However, the positions at which the optical fibers 50a and 50b are arranged are not limited to the above-mentioned configuration. As illustrated in FIG. 14, how the coating material 51 of each of the first optical fiber 50a and the second optical fiber 50b is removed may be the same as that in the above-mentioned embodiment. Further, as illustrated in FIG. 13 to FIG. 15, the elastic tube 30 includes the insertion portion 32 and the projection portion 33, and the adhesive 40 is loaded between the outer peripheral surface of the insertion portion 32 and the inner peripheral surface of the first part 22 of the through hole 21 of the sleeve 20. In this manner, the outer peripheral surface of the insertion portion 32 of the elastic tube 30 and the inner peripheral surface of the first part 22 of the through hole 21 of the sleeve 20 are fixed to each other with the adhesive 40. The axial direction dimension of each of the projection portion 33 and the insertion portion 32 of the elastic tube 30 may be the same as that in the above-mentioned embodiment. The adhesive 40 is also loaded inside of the through hole 31 of the elastic tube 30. In this manner, the outer peripheral surface of the coating material 51 of each of the first optical fiber 50a and the second optical fiber 50b and the inner peripheral surface of the through hole 31 of the elastic tube 30 are fixed to each other. In other words, the elastic tube 30 is attached to the first optical fiber 50a and the second optical fiber 50b.

Further, as illustrated in FIG. 14, similarly to the above-mentioned embodiment, the adhesive 40 is also loaded in a part of the first part 22 of the through hole 21 of the sleeve 20 in which the insertion portion 32 of the elastic tube 30 is absent. With this adhesive 40, the first optical fiber 50a, the second optical fiber 50b, and their coating materials 51 are fixed to the inner peripheral surface of the first part 22 of the through hole 21 of the sleeve 20. Further, the second part 23 of the through hole 21 of the sleeve 20 is filled with the glass 41. In this manner, the first optical fiber 50a and the second optical fiber 50b are fixed to the sleeve 20, and a gap between the inner peripheral surface of the second part 23 of the through hole 21 of the sleeve 20 and each of the first optical fiber 50a and the second optical fiber 50b is sealed.

As described above, the present invention is applicable even when the optical fiber 50 for performing optical communication between the inside and the outside of the package 60 includes two optical fibers 50a and 50b. Further, even with such a configuration, an effect similar to that in the embodiment can be obtained. That is, even when the first optical fiber 50a for transmitting an optical signal from the outside to the inside of the package 60 and the second optical fiber 50b for transmitting an optical signal from the inside to the outside of the package 60 are inserted into the optical fiber feedthrough 1b, the airtightness of the package 60 can be kept. Further, the bending loss of the first optical fiber 50a and the second optical fiber 50b can be reduced, and the desired optical characteristics can be obtained. Further, in this modification example, there is shown a configuration in which two optical fibers 50a and 50b are inserted into the optical fiber feedthrough 1b, but there may be adopted a configuration in which three or more optical fibers are inserted. Even with such a configuration, an effect similar to that in the embodiment can be obtained.

The embodiment and the modification example of the present invention have been described above, but the present invention is not limited to the above-mentioned embodiment or modification example.

For example, in the above-mentioned embodiment, the sleeve 20 is mounted to the package 60 such that its end portion on the second direction D2 side is located outside of the package 60. However, the sleeve 20 may be mounted to the package 60 such that its end portion on the second direction D2 side is exposed from the outer wall 61 of the package 60.

### REFERENCE SIGNS LIST

1a, 1b . . . optical fiber feedthrough, 20 . . . sleeve, 21 . . . through hole of sleeve, 22 . . . first part of through hole of sleeve, 23 . . . second part of through hole of sleeve, 24 large diameter portion of second part of through hole of sleeve, 25 . . . small diameter portion of second part of through hole of sleeve, 30 . . . elastic tube, 31 . . . through hole of elastic tube, 32 . . . insertion portion of elastic tube, 33 . . . projection portion of elastic tube, 40 . . . adhesive, 41 . . . glass, 50 . . . optical fiber, 50a . . . first optical fiber, 50b . . . second optical fiber, 51 . . . coating material, 60 . . . package, 61 . . . outer wall of package, 62 . . . optical element

1. (canceled)

2. (canceled)

3. (canceled)

4. (canceled)

5. (canceled)

6. (canceled)

7. An optical fiber feedthrough for performing optical communication via an optical fiber between an element accommodated inside of an air-tightly-sealed package and any device arranged outside of the package, the optical fiber feedthrough being mountable to the package, the optical fiber feedthrough comprising:
a sleeve which has a tubular shape, and includes an end portion on a first direction side and an end portion on a second direction side, the first direction being one direction along an axial direction and the second direction being an other direction along the axial direction, the sleeve being mountable to the package such that the end portion on the first direction side is located on an inner side of the package and the end portion on the second direction side is located on an outer side of the package, the sleeve further including a through hole which extends in the axial direction and allows communication between the inside and the outside of the package; and
an elastic tube including:
an insertion portion entering the inside of the through hole from an outer end portion being an end portion on the second direction side of both end portions of the through hole of the sleeve; and
a projection portion projecting to the outside of the sleeve from the outer end portion,
wherein the optical fiber is insertable into the through hole of the sleeve and the elastic tube, and
wherein an outer peripheral surface of the elastic tube and an inner peripheral surface of the through hole of the sleeve are fixed to each other with an adhesive.

8. The optical fiber feedthrough according to claim 7, wherein the elastic tube is formed such that, when the elastic tube is bent into an L shape under a state in which the optical fiber is inserted thereinto, a curvature radius of a bending deformation portion of the optical fiber becomes equal to or larger than a curvature radius corresponding to an upper limit value of a standard of a bending loss of the optical fiber.

9. The optical fiber feedthrough according to claim 7, wherein a curvature radius of a bending deformation portion of the elastic tube in a case in which a bending load acts on the elastic tube so that the elastic tube is bent and deformed is larger than a curvature radius of a bending deformation portion of the optical fiber in a case in which the same bending load acts on the optical fiber so that the optical fiber is bent and deformed.

10. The optical fiber feedthrough according to claim 7, wherein a length of the insertion portion of the elastic tube is 1 mm or more, and a length of the projection portion of the elastic tube is 2 mm or more.

11. The optical fiber feedthrough according to claim 7, wherein a thickness of the elastic tube in a direction orthogonal to the axial direction is 0.2 mm or more.

12. The optical fiber feedthrough according to claim 7, wherein the optical fiber includes:
a first optical fiber for transmitting an optical signal from the outside to the inside of the package; and
a second optical fiber for transmitting an optical signal from the inside to the outside of the package.

13. The optical fiber feedthrough according to claim 7,
wherein the optical fiber is fixed to the sleeve and the elastic tube under a state in which the optical fiber is inserted into the through hole of the sleeve and the elastic tube, and
wherein the optical fiber extends from an end portion on the second direction side of the projection portion of the elastic tube.

14. The optical fiber feedthrough according to claim 13, wherein a length of a part of the optical fiber in the axial direction, the part extending from the end portion of the projection portion on the second direction side is longer than a length of the projection portion in the axial direction.

15. The optical fiber feedthrough according to claim 7, wherein a common adhesive is loaded between an outer peripheral surface of the insertion portion of the elastic tube and an inner peripheral surface of the through hole of the sleeve over an entire periphery from an end portion on the first direction side to an end portion on the second direction side of the insertion portion.

16. The optical fiber feedthrough according to claim 7, wherein an adhesive loaded inside of a through hole of the elastic tube and the adhesive loaded between the outer peripheral surface of the insertion portion of the elastic tube and the inner peripheral surface of the through hole of the sleeve are common with each other.
